(19) United States
(12) Patent Application Publication
(10) Pub. No.: US 2018/0033164 A1
(43) Pub. Date: Feb. 1, 2018

(54) ELECTRONIC DEVICE FOR IMPROVING TEXT VISIBILITY AND METHOD OF OPERATING SAME

(71) Applicant: Samsung Electronics Co., Ltd., Gyeonggi-do (KR)

(72) Inventors: Young-Seung SEO, Daegu (KR); Hyun-Woo KIM, Daegu (KR); Eun-Yeung LEE, Gyeongsangbuk-do (KR)

(21) Appl. No.: 15/664,104

(22) Filed: Jul. 31, 2017

(30) Foreign Application Priority Data
Aug. 1, 2016 (KR) 10-2016-0097846

(51) Int. Cl. G06T 11/00; G09G 5/02; G09G 5/10; G06T 11/60; G06T 7/90

(52) U.S. Cl. CPC G06T 11/001; G06T 11/60; G06T 7/90; G09G 5/10; G09G 5/026; G06T 2207/10024; G09G 2340/14; G09G 2320/066; G09G 2320/0666; G09G 2320/0686; G09G 2320/0626

(57) ABSTRACT

An electronic device may include a display; and a processor that selects a first area where text is to be written on a first image displayed on the display, determines a representative color of the first area; determines a color of the text to contrast with the representative color, generates a second image for the first area including the text in the determined color, and displays the second image in the first area of the first image.

### CLAIM OF PRIORITY

This application claims priority under 35 U.S.C. §119(a) to Korean Application Serial No. 10-2016-0097846, which was filed in the Korean Intellectual Property Office on Aug. 1, 2016, the entire content of which is hereby incorporated by reference.

### TECHNICAL FIELD

The present disclosure relates to an electronic device capable of displaying text with improved visibility on the display of the electronic device and a method of operating the same.

### BACKGROUND

Recently, electronic devices including displays, such as smartphones, have proliferated. The displays of the electronic devices may display text and/or images, or display text on background images.

When a conventional electronic device displays text over background images, the visibility of the displayed text may be very low depending on the image. For example, if the color of the image coincides with the color of the text, then the text may be difficult to read.

As another example, when the image includes objects such as cloud or sky where the color of the object is white, the visibility of the text is very low if the color of the text is also white. Likewise, when the image is dark, such as a nighttime image, the visibility of the text is very low if the color of the text is black.

### SUMMARY

A technical solution of the present disclosure is to provide an electronic device and a method of operating the same which, when text is displayed on an image displayed on a display, the text is displayed so that it contrasts with the background image. Accordingly, visibility of the text may be improved.

In accordance with an aspect of the present disclosure, an electronic device is provided. The electronic device includes: a display; and a processor that selects a first area where text is to be written on a first image displayed on the display, determines a representative color of the first area, determines a color of the text to contrast with the representative color, generates a second image for the first area including the text in the determined color, and displays the second image in the first area of the first image.

In accordance with another aspect of the present disclosure, a method of operating an electronic device is provided. The method includes: selecting a first area where text is to be written on a first image displayed on a display; determining a representative color of the first area; determining a color of the text to contrast with the representative color; generating a second image for the first area including the text in the determined color; and displaying the second image in the first area of the first image.

An electronic device according to embodiments of the present disclosure may display text of a color that contrasts with the background images of the text, so as to improve the visibility of the text.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating an electronic device and a network according to one embodiment of the present disclosure;

FIG. 2 is a block diagram of the electronic device according to one embodiment;

FIG. 3 is a block diagram of a program module according to one embodiment;

FIG. 4 is a block diagram schematically illustrating the electronic device according to one embodiment of the present disclosure;

FIG. 5 is a flowchart illustrating an operation method of the electronic device according to one embodiment of the present disclosure;

FIG. 6 is a flowchart illustrating an operation method of determining a representative color of a first area by the electronic device according to one embodiment of the present disclosure;

FIG. 7 is a block diagram illustrating an operation for determining the representative color of the first area by the electronic device according to one embodiment of the present disclosure;

FIG. 8 is a graph illustrating an operation for determining a color of text by the electronic device according to one embodiment of the present disclosure;

FIG. 9 is a flowchart illustrating an operation method of determining the representative color of the first area by the electronic device according to one embodiment of the present disclosure;

FIG. 10 is a flowchart illustrating an operation method of generating a second image based on the representative color of the first area by the electronic device according to one embodiment of the present disclosure;

FIG. 11 is a flowchart illustrating an operation method of storing information regarding the second image by the electronic device according to one embodiment of the present disclosure;

FIG. 12A and FIG. 12B are diagrams illustrating a method of improving the visibility of text by the electronic device according to one embodiment of the present disclosure; and

FIG. 13A, FIG. 13B, FIG. 13C, FIG. 13D and FIG. 13E are diagrams illustrating a method of improving the visibility of text by the electronic device according to one embodiment of the present disclosure.

### DETAILED DESCRIPTION

Hereinafter, various embodiments of the present disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. As used herein, singular forms may include plural forms as well unless the context clearly indicates otherwise. The expression “a first,” “a second,” “the first,” or “the second” used in various embodiments of the present disclosure may modify various components regardless of the order and/or the importance but does not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the present disclosure may be interchangeably used with, for example, “suitable for,” “having the capacity to,” “designed to,” “adapted to,” “made to,” or “capable of” in terms of hardware or software, according to circumstances. Alternatively, in some situations, the expression “device configured to” may mean that the device, together with other devices or components, “is able to.” For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HIVID)), a fabric or clothing integrated type (e.g., an electronic clothing), a body-mounted type (e.g., a skin pad, or tattoo), and a bio-implantable type (e.g., an implantable circuit). In some embodiments, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.). According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be flexible, or may be a combination of one or more of the aforementioned various devices. The electronic device according to one embodiment of the present disclosure is not limited to the above described devices. In the present disclosure, the term “user” may indicate a person using an electronic device or a device (e.g., an artificial intelligence electronic device) using an electronic device.

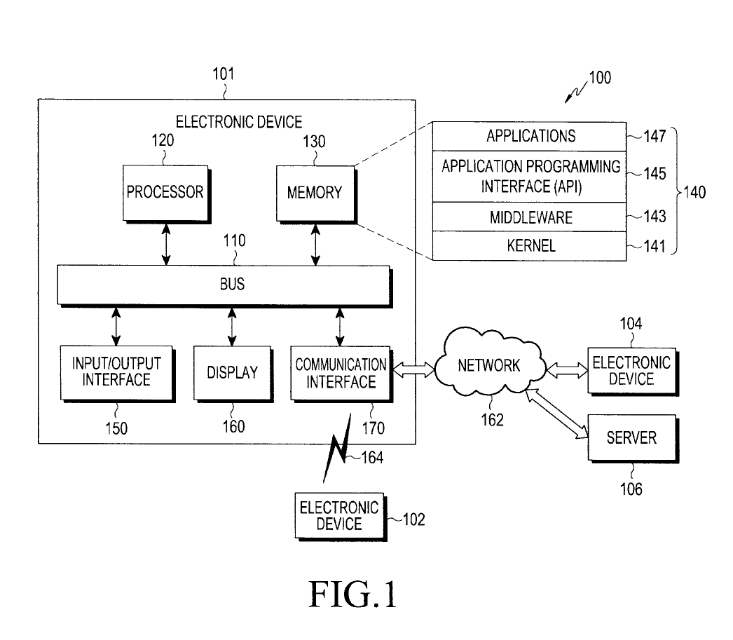

An electronic device 101 in a network environment 100 according to one embodiment will be described with reference to FIG. 1. The electronic device 101 may include a bus 110, a processor 120, a memory 130, an input/output interface 150, a display 160, and a communication interface 170. In some embodiments, the electronic device 101 may omit at least one of the above elements or may further include other elements. The bus 110 may include, for example, a circuit that interconnects the elements 110 to 170 and transmitting communication (for example, control messages or data) between the elements. The processor 120 may include one or more of a central processing unit, an application processor, and a communication processor (CP). The processor 120, for example, may carry out operations or data processing relating to the control and/or communication of at least one other element of the electronic device 101.

The memory 130 may include a volatile and/or non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an application programming interface (API) 145, and/or application programs (or “applications”) 147. At least a part of the kernel 141, the middleware 143, or the API 145 may be referred to as an Operating System (OS). The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data. Furthermore, the middleware 143 may process one or more task requests, which are received from the application programs 147, depending on the priorities thereof. For example, the middleware 143 may assign priorities for using the system resources (for example, the bus 110, the processor 120, the memory 130, or the like) of the electronic device 101 to one or more of the application programs 147, and may process the one or more task requests. The API 145 is an interface used by the application 147 to control a function provided from the kernel 141 or the middleware 143, and may include, for example, at least one interface or function (for example, an instruction) for file control, window control, image processing, character control, or the like. For example, the input/output interface 150 may forward instructions or data, input from a user or an external device, to the other element(s) of the electronic device 101, or may output instructions or data, received from the other element(s) of the electronic device 101, to the user or the external device.

The display 160 may include, for example, a Liquid Crystal Display (LCD), a Light-Emitting Diode (LED) display, an Organic Light-Emitting Diode (OLED) display, a Micro Electro Mechanical System (MEMS) display, or an electronic paper display. The display 160 may display, for example, various types of content (for example, text, images, videos, icons, and/or symbols) for a user. The display 160 may include a touch screen and may receive, for example, a touch, gesture, proximity, or hovering input using an electronic pen or the user's body part. The communication interface 170 may configure communication, for example, between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may include, for example, cellular communication that uses at least one of LTE, LTE-Advance (LTE-A), code division multiple access (CDMA), wideband CDMA (WCDMA), universal mobile telecommunications system (UMTS), wireless broadband (WiBro), global system for mobile communications (GSM), or the like. According to an embodiment, the wireless communication may include, for example, at least one of Wi-Fi, Bluetooth, Bluetooth low energy (BLE), ZigBee, near field communication (NFC), magnetic secure transmission, Radio Frequency (RF), and body area network (BAN). According to an embodiment, the wireless communication may include a GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, in this document, the term “GPS” may be interchangeable with the term “GNSS”. The wired communication may include, for example, at least one of a Universal Serial Bus (USB), a High Definition Multimedia Interface (HDMI), Recommended Standard 232 (RS-232), a Plain Old Telephone Service (POTS), and the like. The network 162 may include a telecommunications network, for example, at least one of a computer network (for example, a LAN or a WAN), the Internet, and a telephone network.

Each of the first and second external electronic devices 102 and 104 may be of a type identical to or different from that of the electronic device 101. According to various embodiments, all or some of the operations executed by the electronic device 101 may be executed by another electronic device, a plurality of electronic devices (for example, external the electronic devices 102 and 104), or the server 106. According to an embodiment, when the electronic device 101 has to perform a function or service automatically or in response to a request, the electronic device 101 may request another device (for example, the external electronic device 102 or 104, or the server 106) to perform at least some functions relating thereto, instead of autonomously or additionally performing the function or service. Another electronic device (for example, the external electronic device 102 or 104) may execute the requested functions or the additional functions, and may deliver the result of execution to the electronic device 101. The electronic device 101 may provide the received result as it is, or may additionally process the received result to provide the requested functions or services. To this end, for example, cloud computing, distributed computing, or client-server computing technology may be used.

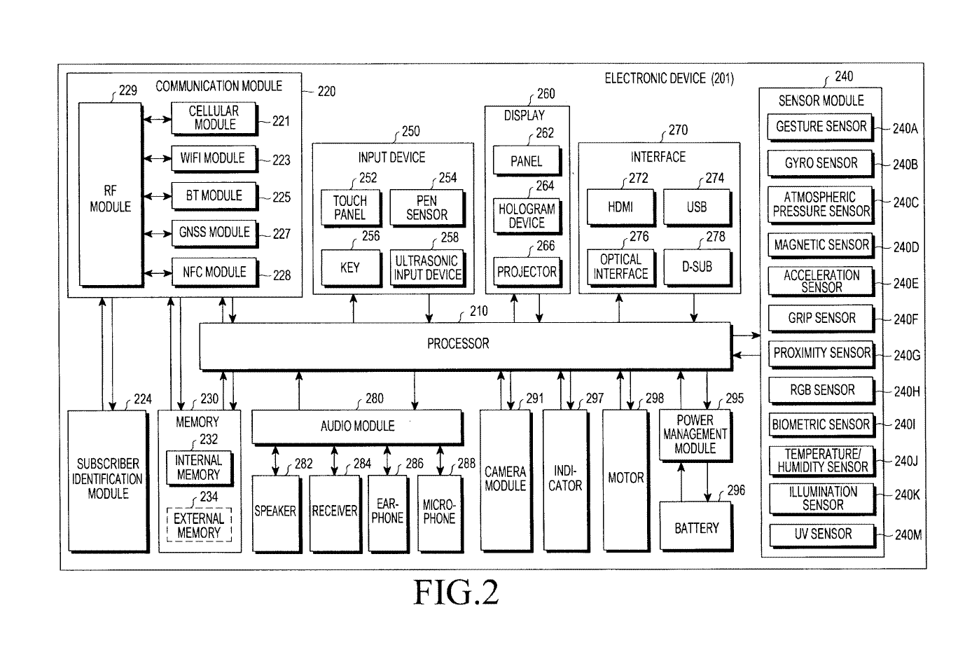

FIG. 2 is a block diagram illustrating an electronic device 201 according to one embodiment. The electronic device 201 may include, for example, all or part of the electronic device 101 illustrated in FIG. 1. The electronic device 201 may include at least one processor 210 (for example, an AP), a communication module 220, a subscriber identification module 224, a memory 230, a sensor module 240, an input device 250, a display 260, an interface 270, an audio module 280, a camera module 291, a power management module 295, a battery 296, an indicator 297, and a motor 298. The processor 210 may control a plurality of hardware or software elements connected to the processor 210 by running, for example, an Operating System (OS) or an application program, and may perform processing and arithmetic operations of various types of data. The processor 210 may be implemented by, for example, a System on Chip (SoC). According to an embodiment, the processor 210 may further include a graphic processing unit (GPU) and/or an image signal processor. The processor 210 may also include at least some of the elements illustrated in FIG. 2 (for example, a cellular module 221). The processor 210 may load, in volatile memory, instructions or data received from at least one of the other elements (for example, a non-volatile memory), process the loaded instructions or data, and store the resultant data in the non-volatile memory.

The communication module 220 may have a configuration identical or similar to that of the communication interface 170 illustrated in FIG. 1. The communication module 220 may include, for example, a cellular module 221, a Wi-Fi module 223, a Bluetooth module 225, a GNSS module 227, an NFC module 228, and an RF module 229. The cellular module 221 may provide, for example, a voice call, a video call, a text message service, an Internet service, or the like through a communication network. According to an embodiment of the present disclosure, the cellular module 221 may identify or authenticate an electronic device 201 in the communication network by using the subscriber identification module (for example, a Subscriber Identity Module (SIM) card) 224. According to an embodiment, the cellular module 221 may perform at least some of the functions that the processor 210 may provide. According to an embodiment, the cellular module 221 may include a communication processor (CP). In some embodiments, at least some (two or more) of the cellular module 221, the Wi-Fi module 223, the Bluetooth module 225, the GNSS module 227, and the NFC module 228 may be included in a single Integrated Chip (IC) or IC package. The RF module 229 may transmit/receive, for example, a communication signal (for example, an RF signal). The RF module 229 may include, for example, a transceiver, a power amp module (PAM), a frequency filter, a low-noise amplifier (LNA), an antenna, or the like. According to another embodiment, at least one of the cellular module 221, the Wi-Fi module 223, the Bluetooth module 225, the GNSS module 227, and the NFC module 228 may transmit/receive an RF signal through a separate RF module. The subscriber identification module 224 may include, for example, a card that includes a subscriber identification module, or an embedded SIM, and may contain unique identification information (for example, an integrated circuit card identifier (ICCID)) or subscriber information (for example, an international mobile subscriber identity (IMSI)).

The memory 230 (for example, the memory 130) may include, for example, an internal memory 232 or an external memory 234. The internal memory 232 may include, for example, at least one of a volatile memory (for example, a DRAM, an SRAM, an SDRAM, or the like) and a non-volatile memory (for example, a one-time programmable ROM (OTPROM), a PROM, an EPROM, an EEPROM, a mask ROM, a flash ROM, a flash memory, a hard disc drive, or a solid state drive (SSD)). The external memory 234 may include a flash drive, for example, a compact flash (CF), a secure digital (SD), a Micro-SD, a Mini-SD, an eXtreme digital (xD), a multimedia card (MMC), a memory stick, and the like. The external memory 234 may be functionally and/or physically connected to the electronic device 201 through any of various interfaces.

The sensor module 240 may, for example, measure a physical quantity or detect the operating state of the electronic device 201 and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and an ultraviolet (UV) sensor 240M. Additionally or alternatively, the sensor module 240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments, the electronic device 201 may further include a processor, which is configured to control the sensor module 240, as a part of the processor 210 or separately from the processor 210 in order to control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. Furthermore, the touch panel 252 may further include a control circuit. The touch panel 252 may further include a tactile layer to provide a tactile reaction to a user. The (digital) pen sensor 254 may include, for example, a recognition sheet that is a part of, or separate from, the touch panel. The key 256 may include, for example, a physical button, an optical key, or a keypad. The ultrasonic input device 258 may detect ultrasonic waves, which are generated by an input tool, through a microphone (for example, a microphone 288) to identify data corresponding to the detected ultrasonic waves.

The display 260 (for example, the display 160) may include a panel 262, a hologram device 264, a projector 266, and/or a control circuit for controlling them. The panel 262 may be implemented to be, for example, flexible, transparent, or wearable. The panel 262, together with the touch panel 252, may be configured as one or more modules. According to an embodiment, the panel 262 may include a pressure sensor (or a POS sensor), which may measure the strength of pressure of a user's touch. The pressure sensor may be implemented so as to be integrated with the touch panel 252 or may be implemented as one or more sensors separate from the touch panel 252. The hologram device 264 may show a three-dimensional image in the air using the interference of light. The projector 266 may display an image by projecting light onto a screen. The screen may be located, for example, in the interior of, or on the exterior of, the electronic device 201. The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280 may bi-directionally convert, for example, a sound and an electric signal. At least some elements of the audio module 280 may be included, for example, in the input/output interface 150 illustrated in FIG. 1. The audio module 280 may process sound information that is input or output through, for example, a speaker 282, a receiver 284, earphones 286, the microphone 288, and the like. The camera module 291 is a device that can capture a still image and a moving image. According to an embodiment, the camera module 291 may include one or more image sensors (for example, a front sensor or a rear sensor), a lens, an image signal processor (ISP), or a flash (for example, an LED or xenon lamp). The power management module 295 may manage, for example, the power of the electronic device 201. According to an embodiment, the power management module 295 may include a power management integrated circuit (PMIC), a charger IC, or a battery or fuel gauge. The PMIC may use a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, the residual amount of the battery 296 and a voltage, current, or temperature while charging. The battery 296 may include, for example, a rechargeable battery and/or a solar battery.

The indicator 297 may display a particular state, for example, a booting state, a message state, a charging state, or the like of the electronic device 201 or a part (for example, the processor 210) of the electronic device 201. The motor 298 may convert an electrical signal into a mechanical vibration and may generate a vibration, a haptic effect, or the like. The electronic device 201 may include a mobile TV support device (for example, a GPU) that may process media data according to a standard, such as digital multimedia broadcasting (DMB), digital video broadcasting (DVB), mediaFlo™, and the like. Each of the above-described component elements of hardware according to the present disclosure may be configured with one or more components, and the names of the corresponding component elements may vary based on the type of electronic device. According to various embodiments, the electronic device (e.g., the electronic device 201) does not include some elements or further include additional elements. Some of elements are coupled to constitute one object but the electronic device may perform the same functions as those which the corresponding elements have before being coupled to each other.

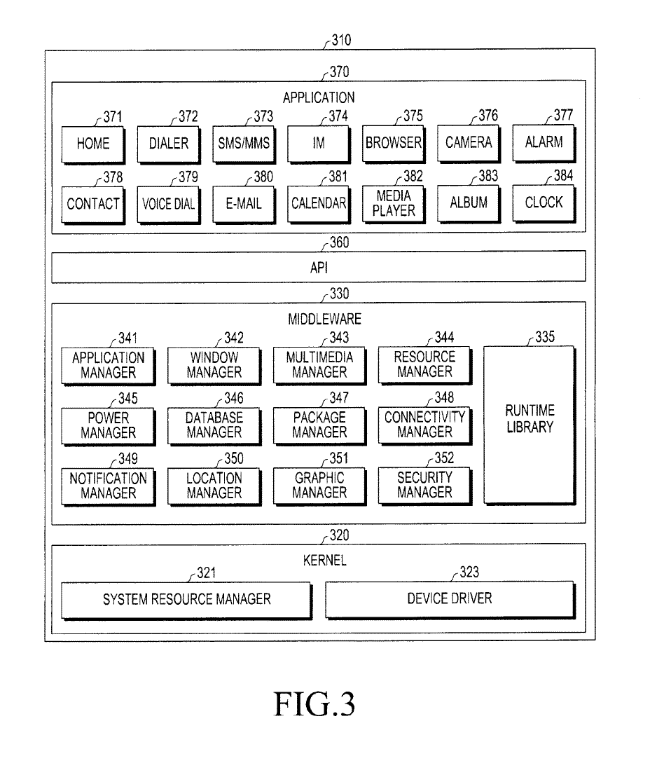

FIG. 3 is a block diagram of a program module according to one embodiment. According to an embodiment, the program module 310 (for example, the program 140) may include an Operating System (OS) for controlling resources related to the electronic device (for example, the electronic device 101) and/or various applications (for example, the application programs 147) executed in the operating system. The operating system may include, for example, Android™, iOS™, Windows™, Symbian™, Tizen™, or Bada™. Referring to FIG. 3, the program module 310 may include a kernel 320 (for example, the kernel 141), middleware 330 (for example, the middleware 143), an API 360 (for example, the API 145), and/or applications 370 (for example, the application programs 147). At least some of the program module 310 may be preloaded on the electronic device, or may be downloaded from an external electronic device (for example, the external electronic device 102 or 104, or the server 106).

The kernel 320 may include, for example, a system resource manager 321 and/or a device driver 323. The system resource manager 321 may control, allocate, or retrieve system resources. According to an exemplary embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver. The middleware 330 may provide, for example, a function required by the applications 370 in common, or may provide various functions to the applications 370 through the API 360 such that the applications 370 can efficiently use the limited system resources within the electronic device. According to an embodiment, the middleware 330 may include at least one of a runtime library 335, an application manager 341, a window manager 342, a multi-media manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses in order to add a new function through a programming language while the applications 370 are being executed. The runtime library 335 may manage input/output, manage memory, or process an arithmetic function. The application manager 341 may manage, for example, the life cycles of the applications 370. The window manager 342 may manage GUI resources used for a screen. The multimedia manager 343 may identify formats required for reproducing various media files and may encode or decode a media file using a codec suitable for the corresponding format. The resource manager 344 may manage the source code of the applications 370 or the space in memory. The power manager 345 may manage, for example, the capacity or power of a battery and may provide power information required for operating the electronic device. According to an embodiment, the power manager 345 may operate in conjunction with a basic input/output system (BIOS). The database manager 346 may, for example, generate, search, or change databases to be used by the applications 370. The package manager 347 may manage the installation or update of an application that is distributed in the form of a package file.

The connectivity manager 348 may manage, for example, a wireless connection. The notification manager 349 may provide an event (for example, an arrival message, an appointment, a proximity notification, or the like) to a user. The location manager 350 may manage, for example, the location information of the electronic device. The graphic manager 351 may manage a graphic effect to be provided to a user and a user interface relating to the graphic effect. The security manager 352 may provide, for example, system security or user authentication. According to an embodiment, the middleware 330 may include a telephony manager for managing a voice or video call function of the electronic device or a middleware module that is capable of forming a combination of the functions of the above-described elements. According to an embodiment, the middleware 330 may provide a module specified for each type of OS. Furthermore, the middleware 330 may dynamically remove some existing elements, or may add new elements. The API 360 is, for example, a set of API programming functions, and may be provided with different configurations corresponding to operating systems. For example, in the case of Android or iOS, one API set may be provided for each platform, and in the case of Tizen, two or more API sets may be provided for each platform.

The applications 370 may include, for example, one or more applications that can perform functions such as home 371, a dialer 372, SMS/MMS 373, instant messaging (IM) 374, a browser 375, a camera 376, an alarm 377, contacts 378, voice dialing 379, e-mail 380, a calendar 381, a media player 382, an album 383, a watch 384, health-care applications (for example, for measuring exercise quantity or blood glucose), environment information (for example, atmospheric pressure, humidity, or temperature information) provision applications, and the like. According to an embodiment, the applications 370 may include an information exchange application that can support the exchange of information between the electronic device and an external electronic device. The information exchange application may include, for example, a notification relay application for relaying particular information to an external electronic device or a device management application for managing an external electronic device. For example, the notification relay application may relay notification information generated in the other applications of the electronic device to an external electronic device, or may receive notification information from an external electronic device to provide the received notification information to a user. The device management application may install, delete, or update functions of an external electronic device that communicates with the electronic device (for example, turning on/off the external electronic device itself (or some elements thereof) or adjusting the brightness (or resolution) of a display) or applications executed in the external electronic device. According to an embodiment, the applications 370 may include applications (for example, a health care application of a mobile medical appliance) that are designated according to the attributes of an external electronic device. According to an embodiment, the applications 370 may include applications received from an external electronic device. At least some of the program module 310 may be implemented (for example, executed) by software, firmware, hardware (for example, the processor 210), or a combination of two or more thereof, and may include a module, a program, a routine, an instruction set, or a process for performing one or more functions.

The term “module” used herein may include a unit consisting of hardware, software, or firmware, and may, for example, be used interchangeably with the term “logic,” “logical block,” “component,” “circuit,” or the like. The “module” may be an integrated component, or a unit for performing one or more functions or a part thereof. The “module” may be mechanically or electronically implemented and may include, for example, an Application-Specific Integrated Circuit (ASIC) chip, a Field-Programmable Gate Arrays (FPGA), or a programmable-logic device, which has been known or are to be developed in the future, for performing certain operations. At least some of devices (e.g., modules or functions thereof) or methods (e.g., operations) according to various embodiments may be implemented by an instruction which is stored a computer-readable storage medium (e.g., the memory 130) in the form of a program module. The instruction, when executed by a processor (e.g., the processor 120), may cause the one or more processors to execute the function corresponding to the instruction. The computer-readable storage medium may include a hard disk, a floppy disk, a magnetic medium (e.g., a magnetic tape), an Optical Media (e.g., CD-ROM, DVD), a Magneto-Optical Media (e.g., a floptical disk), an inner memory, etc. The instruction may include a code which is made by a compiler or a code which may be executed by an interpreter. The programming module according to the present disclosure may include one or more of the aforementioned elements or may further include other additional elements, or some of the aforementioned elements may be omitted. Operations performed by a module, a programming module, or other elements according to various embodiments may be executed sequentially, in parallel, repeatedly, or in a heuristic manner. At least some operations may be executed according to another sequence, may be omitted, or may further include other operations.

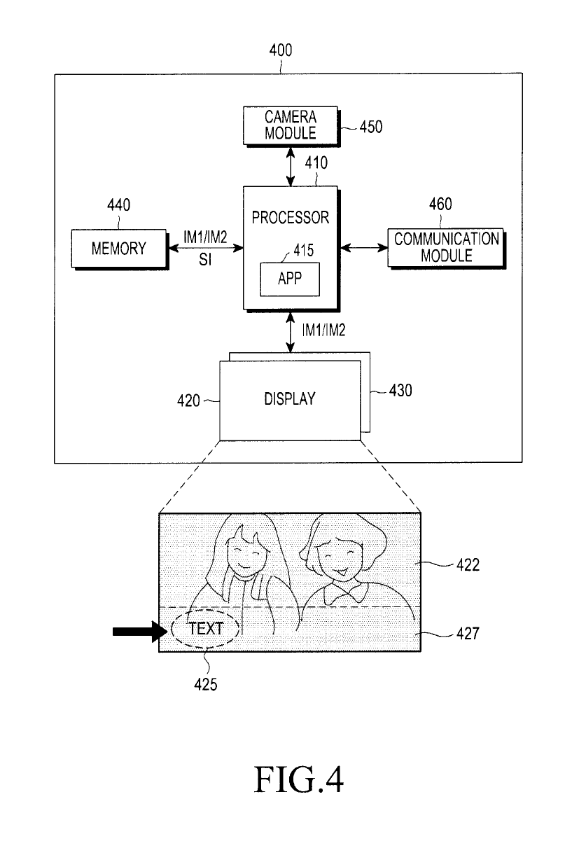

FIG. 4 is a block diagram schematically illustrating an electronic device according to one embodiment of the present disclosure.

Referring to FIG. 4, an electronic device 400 may display image and further display text superimposed on the image.

According to some embodiments, the electronic device 400 may improve the visibility of the text superimposed on the image. Further, the electronic device 400 may improve the visibility of the text superimposed on the image and display the image including the visibility-improved text.

For example, the electronic device 400 may be implemented to be substantially the same as or similar to the electronic devices 101 and 201 described in FIGS. 1 and 2.

The electronic device 400 may include a processor 410, a display 420, a touch screen 430, a memory 440, a camera module 450, and a communication module 460.

The processor 410 may control the overall operation of the electronic device 400. The processor 410 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

According to some embodiments, the processor 410 may display text on a first image (IM1) displayed through the display 420. Further, the processor 410 may improve the visibility of the text.

The first image (IM1) may be an image and/or image data displayed through the display 420. For example, the first image (IM1) may be an image (or image data) where there is initially no text.

A second image (IM2) may be an image corresponding to the first image (IM1) with the text superimposed. Further, the second image (IM2) may be an image (or image data) where the visibility of the text is improved.

According to an embodiment, the processor 410 may load an application stored in the memory 440 into RAM and execute the loaded application. For example, the application 415 may be an application for superimposing text on the first image (IM1). Further, the application 415 may be an application for superimposing text on the first image (IM1) and generating (or displaying) the second image (IM2) that includes the superimposed text.

Hereinafter, for convenience of description, an operation instruction stored in the application 415 will be described as an operation performed by the processor 410. For example, some or all of the operations performed by the processor 410 may be operations stored in the application 415.

The processor 410 may display the first image (IM1) 422 displayed on the display 420. The processor 410 may set a first area 427 in which text 425 is to be superimposed on the first image (IM1) 422.

The first area 427 may be set to be various shapes and/or sizes depending on the text 425. Further, the first area 427 may be manually set by the user or may be automatically set by the processor 410.

The processor 410 may extract representative color of the first area 427 from the first area 427. The processor 410 may determine the color of the text 425 based on the extracted representative color. For example, the processor 410 may determine the color of the text 425 to contrast with the representative color of the first area 427.

Thereafter, the processor 410 may generate the second image (IM2) including text for the first area 427 where the visibility of the text is improved.

The processor 410 may display the second image (IM2) in the first area 427 of the first image (IM1). Alternatively, the processor 410 may display the second image (IM2) such that the second image (IM2) overlaps the first area 427 of the first image (IM1).

The processor 410 may generate a third image by synthesizing the first image (IM1) and the second image (IM2). Further, the processor 410 may display the third image through the display 420.

The processor 410 may store information (SI) regarding the second image (IM2) in the memory 440 based on the first image (IM1) and the text. For example, the information (SI) regarding the second image (IM2) may include the color of the text, the location of the first area 427, the size of the first area 427, the representative color of the first area 427, and/or setting information of the first area 427 for improving the visibility of the text (for example, information on brightness, saturation, and/or transparency).

According to an embodiment, the information (SI) regarding the second image (IM2) may be based on the first image (IM1) and the text superimposed on the first image (IM1).

The processor 410 may generate and display the second image (IM2) based on the information (SI) regarding the second image (IM2) stored in the memory 440.

Further, the processor 410 may store the first image (IM1) and the second image (IM2) in the memory 440. In addition, the processor 410 may also store the third image generated by synthesizing the first image (IM1) and the second image (IM2).

The display 420 may display images under the control of the processor 410. For example, the display 420 may display the first image (IM1) 422. Further, the display 420 may display the second image (IM2) in the first area 427 of the first image (IM1) 422. The display 420 may display the third image generated by synthesizing the first image (IM1) 422 and the second image (IM2).

The display 420 may include a plurality of pixels. For example, the display 420 may display an image composed of a plurality of pixels.

The touch panel 430 may receive a touch from the user.

For example, the touch panel 430 may be a component of the display 420. In this case, the display 420 may be a touch screen.

According to an embodiment, the touch panel 430 may receive a touch input from the user at the first area 427 where the text is displayed. For example, the processor 410 may set the area at or near the touch input as the first area 427.

The memory 440 may store the information (SI) regarding the second image (IM2). Further, the memory 440 may store the application 415. For example, the memory 440 may be implemented as non-volatile memory and/or volatile memory.

The camera module 450 may photograph and generate image data under the control of the processor 410. For example, the camera module 450 may photograph and generate the first image (IM1).

The communication module 460 may receive image data from another electronic device under the control of the processor 410. For example, the communication module 460 may receive the first image (IM1) from another electronic device.

The communication module 460 may transmit the first image (IM1) and/or the second image (IM2) to another electronic device. Further, the communication module 460 may transmit the third image generated by synthesizing the first image (IM1) and the second image (IM2) to another electronic device.

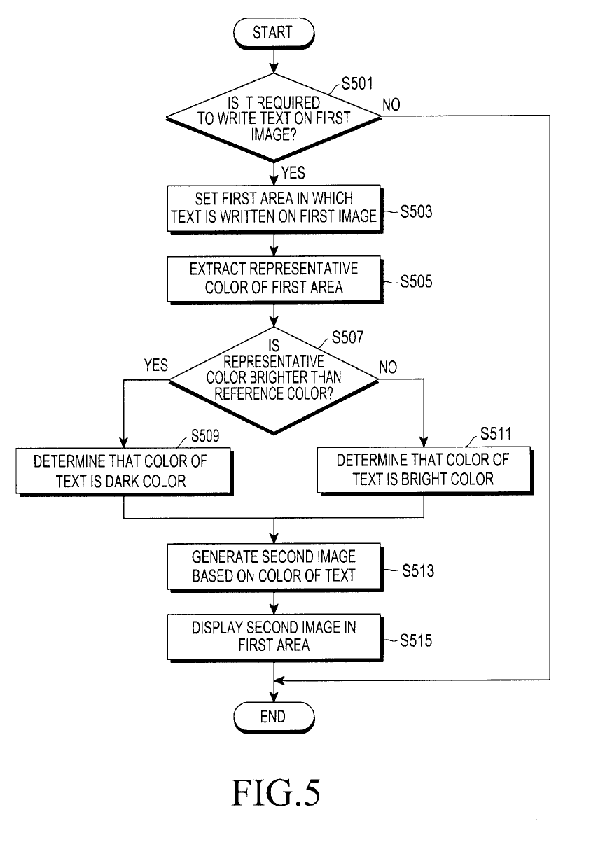

FIG. 5 is a flowchart illustrating an operation method of the electronic device according to one embodiment of the present disclosure.

Referring to FIG. 5, the processor 410 may have already displayed the first image (IM1) on the display 420.

The processor 410 may determine whether it is required to write or superimpose text on the first image (IM1) in S501. For example, the processor 410 may determine whether there is a request for displaying the text on the first image (IM1). For example, the processor 410 may determine whether the application 415 is being executed, where the application 415 contains the request to display text on the first image (IM1).

When there is a request for displaying the text (Yes in S501), the processor 410 may set the first area in which the text is written on the first image (IM1) in S503.

For example, the first area may be set by a user's touch input on the touch screen or may be automatically set by the processor 410.

Further, the first area may be set based on the size of the text to be displayed. For example, the first area may be set as a rectangular or circular area encapsulating the text to be displayed.

Meanwhile, when there is no request for displaying the text (No in S501), the operation shown in FIG. 5 may end.

The processor 410 may extract the representative color of the first area in S505. For example, the representative color may refer to a color corresponding to the average color value of pixels included in the first area. That is, the processor 410 may measure the average color value of the pixels included in the first area and determine a color corresponding to the average value as the representative color. However, such a method of calculating the average value may be inaccurate when there are anomalous pixels, i.e. pixels with color values that are vastly different from the majority of the pixels. Therefore, alternatively, during the determination of the average color value, the processor 410 may exclude pixels whose color values differ from the average value by a predetermined threshold.

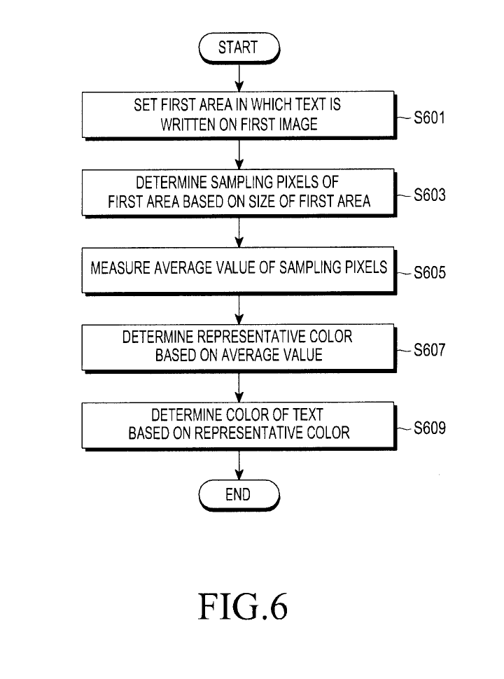

A method by which the processor 410 extracts the representative color of the first area will be described in more detail with reference to FIGS. 6, 7, and 9.

The processor 410 may determine whether the extracted representative color is brighter than a reference color in S507. For example, the reference color may be a standard color or value to determine whether the representative color is bright or dark.

This will be described in detail with reference to FIG. 8.

FIG. 8 is a graph illustrating an operation for determining a color of text by the electronic device according to one embodiment of the present disclosure.

According to an embodiment, the processor 410 may compare the extracted representative color to a reference color corresponding to a reference value (PV) and determine the color of the text that contrasts with the representative color.

The processor 410 may compare the representative color extracted from the first area and the reference value (PV) and determine whether the representative color is bright or dark. The processor 410 may correspondingly set the reference value (PV) to determine whether the extracted representative color is bright or dark. For example, the processor 410 may set the reference value (PV) to be at the center of the RGB scale, as shown in FIG. 8.

For example, when the reference value (PV) is 100 and the value corresponding to the representative color is 80, the processor 410 may determine that the representative color is dark. Conversely, when the reference value (PV) is 100 and the value corresponding to the representative color is 200, the processor 410 may determine that the representative color is bright.

When the extracted representative color is brighter than the reference color corresponding to the reference value (PV) (Yes in S507), the processor 410 may determine the color of the text to be dark in S509. That is, the processor 410 may determine the color of the text to contrast with the representative color. For example, when the representative color is brighter than the reference color, the processor 410 may set the color of the text to black.

When the extracted representative color is darker than the reference color (No in S507), the processor 410 may determine the color of the text to be bright in S511. For example, when the representative color is darker than the reference color, the processor 410 may set the color of the text to white.

The processor 410 may generate the second image (IM2) based on the determined color of the text in S513.

According to an embodiment, the processor 410 may generate the second image (IM2) including text for the first area in which the visibility of the text is improved.

In generating the second image (IM2), the processor 410 may further adjust the brightness and saturation of the first area. Additionally, in generating the second image (IM2), the processor 410 may apply gradation effects to the first area by adjusting the transparency of the first area.

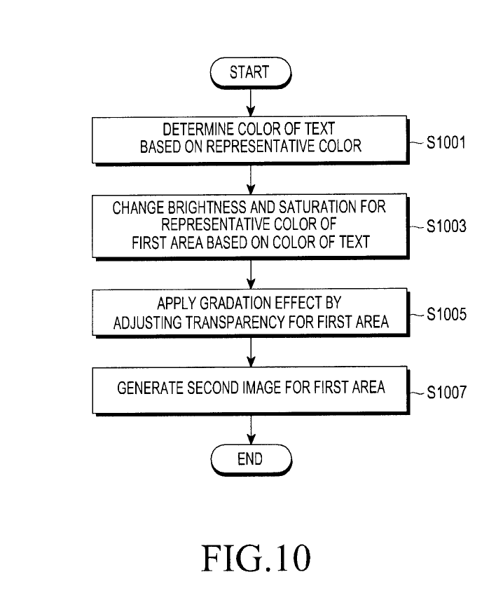

A method by which the processor 410 generates the second image (IM2) will be described in more detail with reference to FIG. 10.

At S515, the processor 410 may display the second image (IM2) in the first area of the first image (IM1) through the display 420. For example, the processor 410 may display the first image (IM1) and the second image (IM2) such that they overlap each other.

Alternatively, the processor 410 may generate a third image by synthesizing the first image (IM1) and the second image (IM2) and then display the third image on the display.

FIG. 6 is a flowchart illustrating an operation method of determining the representative color of the first area by the electronic device according to one embodiment of the present disclosure.

Referring to FIG. 6, the processor 410 may display the first image (IM1) on the display 420. The processor 410 may receive an instruction to write or superimpose text on the first image (IM1).

The processor 410 may set the first area in which the text will be written on the first image (IM1) in S601.

According to an embodiment, the processor 410 may determine the sampling pixels required for determining the representative color of the first area.

The processor 410 may determine sampling pixels of the first area based on the size of the first area in S603. For example, the sampling pixels may be determined based on the horizontal width and the vertical size height of the first area.

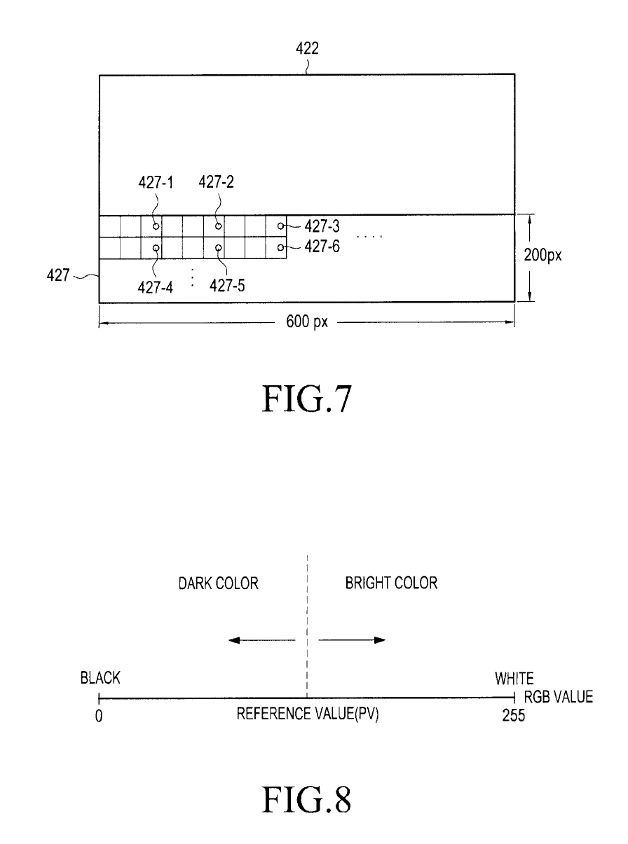

This will be described in detail with reference to FIG. 7.

FIG. 7 is a block diagram illustrating an operation for determining the representative color of the first area by the electronic device according to one embodiment of the present disclosure.

The processor 410 may display the first image (IM1) 422 on the display 420. Further, the processor 410 may set the first area 427 in which text will be superimposed on the first image 422.

According to an embodiment, the processor 410 may determine sampling pixels 427-1 to 427-N (N is a natural number larger than or equal to 2) for determining the representative color of the first area 427.

For example, when the horizontal width of the first area 427 is 600 pixels and the vertical height is 200 pixels, the processor 410 may determine that one out of every three pixels is to be used as a sampling pixel.

As another example, when the horizontal width of the first area is 200 pixels and the vertical height is 100 pixels, the processor 410 may determine that one out of every two pixels is a sampling pixel.

The processor 410 may measure an average color value of the sampling pixels in S605.

For example, when the horizontal width of the first area 427 is 600 pixels and the vertical height is 200 pixels, the processor 410 may measure the average value of the sampling pixels 427-1 to 427-N.

Further, the processor 410 may measure the average value while excluding anomalous pixels whose color value differs from the measured average value by a predetermined threshold. Such an anomalous pixel may be referred to as having a value larger than or equal to a preset value.

The processor 410 may determine the representative color based on the measured average value in S607. For example, the processor 410 may determine that a color corresponding to the measured average value is the representative color. The average value may be determined based on the RGB scale.

The processor 410 may determine the color of the text to be written in the first area based on the determined representative color in S609. For example, the processor 410 may determine the color of the text to contrast with the representative color.

Accordingly, the processor 410 may improve the visibility of the text written in the first area.

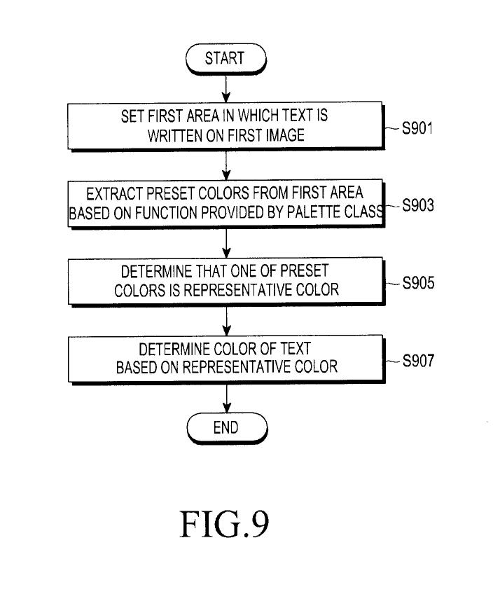

FIG. 9 is a flowchart illustrating an operation method of determining the representative color of the first area by the electronic device according to one embodiment of the present disclosure.

Referring to FIG. 9, the processor 410 may display the first image (IM1) on the display 420. The processor 410 may receive an instruction to write or superimpose text on the first image (IM1).

The processor 410 may set the first area in S901 for the text.

The processor 410 may extract preset colors from the first area based on a palette class in S903. For example, the processor 410 may extract preset colors from pixels included in the first area.

For example, the palette class may include a vibrant color, a vibrant dark color, a vibrant muted color, a muted color, a muted dark color, and a muted light color. The processor 410 may categorize colors from the first area according to these categories in the palette class.

The processor 410 may determine that one of the preset colors is the representative color in S905. For example, the processor 410 may determine that the most frequently occurring preset color is the representative color.

The processor 410 may determine the color of the text based on the determined representative color in S907, such as determining the color of the text to contrast with the representative color. For example, when the representative color is the vibrant color, the processor 410 may determine that the color of the text should be a muted color.

Accordingly, the processor 410 may improve the visibility of the text written or superimposed in the first area.

FIG. 10 is a flowchart illustrating an operation method of generating the second image based on the representative color of the first area by the electronic device according to one embodiment of the present disclosure.

Referring to FIG. 10, the processor 410 may extract the representative color of the first area in which the text is written.

The processor 410 may determine the color of the text based on the extracted representative color in S1001 to contrast with the representative color. For example, when the representative color is bright, the processor 410 may select the color of the text to be dark (for example, black). Conversely, when the representative color is dark, the processor 410 may select the color of the text to be bright (for example, white).

The processor 410 may adjust (or change) the brightness and saturation of the representative color of the first area based on the determined color of the text in S1003.

According to an embodiment, when the color of the text is dark (for example, black), the processor 410 may decrease the saturation and increase the brightness of the representative color. That is, the processor 410 may desaturate the representative color and increase the brightness thereof.

When the color of the text is bright (for example, white), the processor 410 may increase the saturation of the representative color and decrease the brightness thereof. That is, the processor 410 may make the representative color more saturated and decrease the brightness.

The processor 410 may then apply a gradation effect to the first area where the brightness and the saturation are adjusted. According to an embodiment, the processor 410 may apply the gradation effect by adjusting the transparency of the first area in S1005. For example, the processor 410 may apply the gradation effect vertically or horizontally. Further, the processor 410 may provide the gradation effect to the first area using alpha blending. For example, the processor 410 may set the transparent ratio of alpha blending to be 40 to 50%.

Therefore, the processor 410 may provide the gradation effect to the first area by adjusting at least one of brightness, saturation, and transparency.

The processor 410 may then generate the second image (IM2) for the first area where the gradation effect is applied and the brightness and saturation of the representative color are adjusted.

Further, the processor 410 may display the second image (IM2) in the first area of the first image (IM1).

Accordingly, the processor 410 may improve the visibility of the text written in the first area using gradation effects and by adjusting the brightness and the saturation of the representative color.

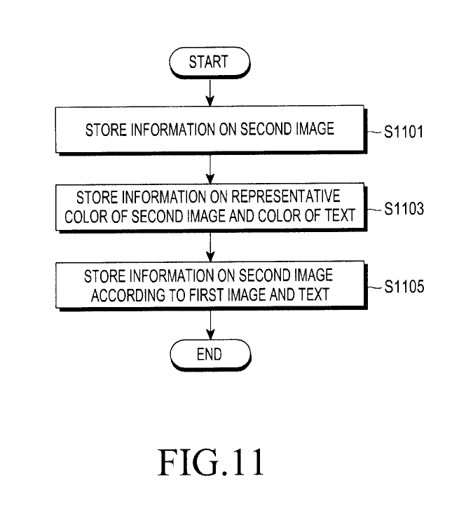

FIG. 11 is a flowchart illustrating an operation method of storing information regarding the second image by the electronic device according to one embodiment of the present disclosure.

Referring to FIG. 11, the second image (IM2) for the first area may be generated. Further, the processor 410 may display the second image (IM2) in the first area of the first image (IM1).

The processor 410 may store information (SI) regarding the second image (IM2) in the memory 440 in S1101.

For example, the information (SI) regarding the second image (IM2) may include information on the location or the size of the first area, information on the representative color of the first area, information on the typeface or the font of the text written in the first area, information on the color of the text written in the first area, information on the location of the text written in the first area, information on brightness and saturation of the representative color, information on the adjusted value of the transparency for the first area, and/or information on a gradation effect applied to the first area.

According to an embodiment, the processor 410 may also store information regarding the representative color of the second image (IM2) and the color of the text in S1103. For example, the processor 410 may store the information on the representative color of the first area and the color of the text based on the representative color.

The processor 410 may store information (SI) regarding the second image (IM2) in the memory 440 according to the first image (IM1) in S1105. For example, the processor 410 may separately store the information (SI) regarding the second image (IM2) according to the kind or type of the first image (IM1). Further, the processor 410 may store the information (SI) depending on the text written in the first image (IM1) in S1105.

For example, the processor 410 may have stored information (SI) on a second image (IM2) based on a certain text string to be displayed in a certain first area of the first image (IM1). When the same (or similar) new text is written in the same (or similar) area in the first image (IM1), the processor 410 may extract representative color information and text color information from previously stored information (SI). Accordingly, the processor 410 may be prevented from performing unnecessary processing. Further, the processor 410 may adjust at least one of the brightness, saturation, and transparency of the representative color based on the previously stored information (SI).

That is, when the same (or similar) new text is written in the same (or similar) area in the first image (IM1), the processor 410 may generate the new second image (IM2) based on the information (SI) regarding an earlier second image (IM2). Further, when the same (or similar) text is written in the same (or similar) area in the first image (IM1), the processor 410 may display the new second image (IM2) in the same (or similar) area in the first image (IM1) based on the information (SI) on the earlier second image (IM2).

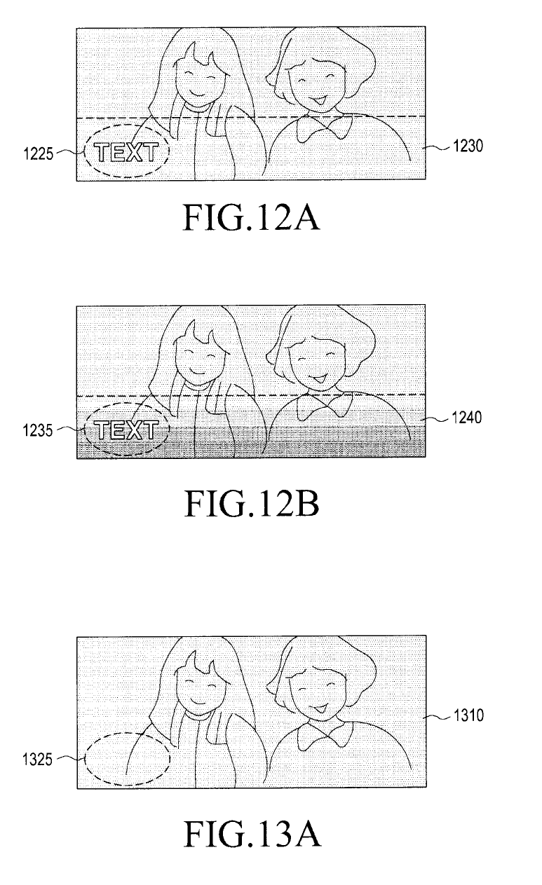

FIGS. 12A and 12B are diagrams illustrating a method of improving the visibility of text by the electronic device according to one embodiment of the present disclosure.

FIG. 12A is a diagram in which the processor 410 displays text without the visibility improvement operations described above.

Referring to FIG. 12A, the processor 410 may determine the color of the text as white and display the second image (IM2) in the first area 1230.

At this time, since the brightness, saturation, and transparency for the representative color are not adjusted in the first area 1230 of FIG. 12A, the visibility of the text written in the first area 1230 may not be improved.

FIG. 12B is a diagram in which the processor 410 displays text with improved visibility.

Referring to FIG. 12B, the processor 410 may determine the color of the text as white and display the second image (IM2) in the first area 1240 where the brightness, saturation, and transparency for the representative color of the first area 1230 have been adjusted. Further, the processor 410 may display the second image (IM2) with a gradation effect in the first area 1240 by adjusting the brightness, the saturation, and the transparency for the representative color of the first area 1240.

At this time, since the brightness, the saturation, and the transparency for the representative color are adjusted in the first area 1240 of FIG. 12B, the visibility of the text written in the first area 1240 may be improved.

That is, compared to the visibility of text 1225 displayed in the first area 1230 illustrated in FIG. 12A, the visibility of text 1235 displayed in the first area 1240 illustrated in FIG. 12B may be improved.

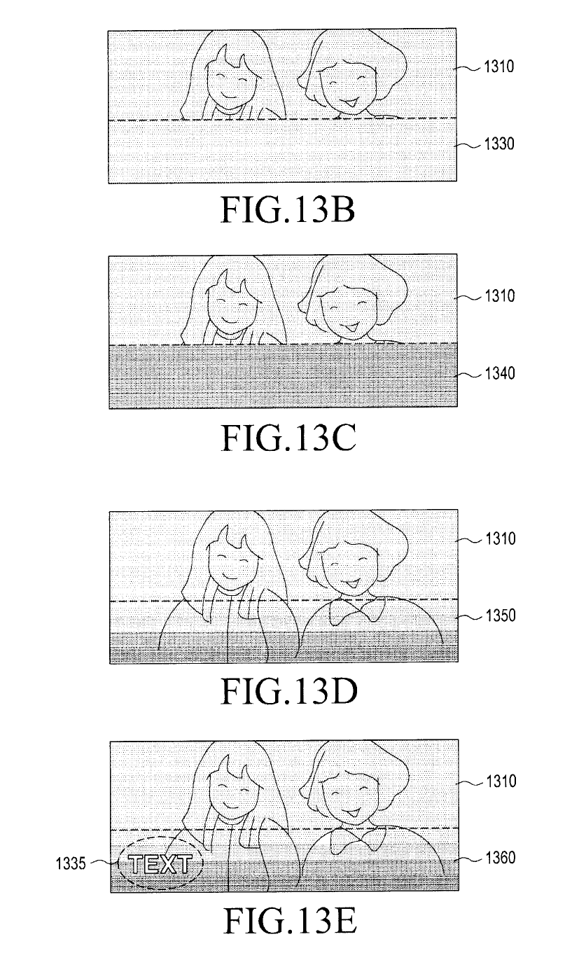

FIGS. 13A to 13E are diagrams illustrating a method of improving the visibility of text by the electronic device according to one embodiment of the present disclosure.

Referring to FIG. 13A, the processor 410 may display a first image (IM1) 1310 on the display 420. The processor 410 may determine whether there is a request for writing or displaying text on the first image (IM1) 1310. For example, the processor 410 may determine whether there is a request from the application 415 to superimpose text on the first image (IM1) 1310.

When there is a request for writing the text, the processor 410 may set an area 1325 in which text is to be written on the first image (IM1) 1310. At this time, the area in which the text is written may be selected by the user or may be automatically selected by the processor 410.

Referring to FIG. 13B, the processor 410 may set a first area 1330 based on the area 1325. The first area 1330 may be determined based on the size and location of the area 1325. Further, the first area 1330 may be set by a user's selection or may be automatically set by the processor 410.

The processor 410 may extract the representative color of the first area 1330. For example, the processor 410 may extract the representative color of the first area 1330 based on the average color value of sampled pixels in the first area 1330.

The processor 410 may then determine the color of the text to be written based on the representative color of the first area 1330. For example, when the representative color of the first area 1330 is darker than a reference color, the processor 410 may determine that the color of the text should be bright, for example white.

Referring to FIG. 13C, the processor 410 may adjust the representative color of the first area 1330. For example, the processor 410 may adjust the brightness and saturation of the representative color of the first area 1330. The brightness and saturation of the representative color of the first area 1330 may be adjusted by a user's selection or may be automatically adjusted by the processor 410. The processor 410 may adjust the brightness and the saturation for the representative color by converting the RGB-type representative color into the HSV-type color model.

For example, when it is determined that the color of the text is bright (for example, white), the processor 410 may decrease the brightness for the representative color of the first area 1330 and increase the saturation.

Further, when it is determined that the color of the text is dark (for example, black), the processor 410 may increase the brightness and decrease the saturation for the representative color of the first area 1330.

Referring to FIG. 13D, the processor 410 may apply a gradation effect to a first area 1350 to contrast the second image (IM2) with the first image (IM1).

For example, the processor 410 may set the start color for the gradation effect to be the representative color) and the final color as being fully transparent. The processor 410 may then apply the gradation effect where the start color is at the bottom of the first area 1350 and the final color is at the top of the first area 1350.

Further, the processor 410 may apply the gradation effect through alpha-blending scheme to adjust transparency. For example, the processor 410 may set the alpha ratio of the alpha-blending scheme to be 40 to 50%.

Referring to FIG. 13E, the processor 410 may write text 1335 in the first area 1360. For example, the processor 410 may write the text 1335 in the area 1325. At this time, the color of the text may be the color determined in FIG. 13B. Further, the font or the size of the text may be determined by a user's selection or the processor 410.

The processor 410 may also perform the above operations by generating a second image (IM2) having the text 1335 written in the first area 1360. For example, the processor 410 may apply the gradation effect to the first area 1360, adjust the brightness and saturation of the representative color of the first area 1360, display the text 1335, and store the altered first area 1360 as the second image (IM2).

The processor 410 may display the second image (IM2) in the first area 1360 of the first image. For example, the processor 410 may display the second image (IM2) so as to overlap the first area 1360 of the first image.

Further, the processor 410 may generate a third image by synthesizing the first image (IM1) and the second image (IM2) and display the third image.

The processor 410 may store the second image (IM2) and/or the third image in the memory 440. Further, the processor 410 may store information (SI) regarding the second image (IM2) in the memory 440.

An electronic device according to one embodiment of the present disclosure may include a display; and a processor that selects a first area where text is to be written on a first image displayed on the display, determine a representative color of the first area; determines a color of the text to contrast with the representative color, generates a second image for the first area including the text in the determined color, and displays the second image in the first area of the first image.

The processor may compare the representative color and a reference color to determine the color of the text based on the comparison.

The processor may determine that the color of the text is dark when the representative color is brighter than the reference color, and may determine that the color of the text is bright when the representative color is darker than the reference color.

The processor may adjust the brightness and saturation of the second image based on the color of the text and/or the representative color.

The processor may decrease the brightness and increase the saturation of the second image when the color of the text is bright, and may increase the brightness and decrease the saturation of the second image when the color of the text is dark.

The processor may provide a gradation effect by adjusting at least one of the brightness, saturation, and transparency of the second image.

The processor may select sampling pixels included in the first area based on a size of the first area and may determine the representative color based on an average color value of the sampling pixels.

The processor may exclude a pixel from the sampling pixels when a difference between a color value of the pixel and the average color value is larger than or equal to a preset value.

The electronic device may further include a memory, and the processor may store information associated with the second image in the memory.

A method of operating an electronic device may include: an operation of selecting a first area where text is to be written on a first image displayed on a display; an operation of determining a representative color of the first area; an operation of determining a color of the text to contrast with the representative color; an operation of generating a second image for the first area including the text in the determined color; and an operation of displaying the second image in the first area of the first image.

The operation of determining the color of the text may include an operation of comparing the representative color and a reference color and determining the color of the text based on the comparison.

The operation of determining the color of the text may include an operation of determining that the color of the text is dark when the representative color is brighter than the reference color, and determining that the color of the text is bright when the representative color is darker than the reference color.

The operation of generating the second image may include an operation of adjusting the brightness and saturation of the second image based on the color of the text and/or the representative color.

The operation of generating the second image may include an operation of decreasing the brightness and increasing the saturation of the second image when the color of the text is bright, and increasing the brightness and decreasing the saturation of the second image when the color of the text is dark.

The operation of generating the second image may include an operation of providing a gradation effect by adjusting at least one of the brightness, saturation, and transparency of the second image.

The operation of determining of the representative color may include an operation of selecting sampling pixels included in the first area based on a size of the first area and an operation of determining the representative color based on an average color value of the sampling pixels.

The operation of determining of the representative color may further include an operation of excluding a pixel from the sampling pixels when a difference between a color value of the pixel and the average color value is larger than or equal to a preset value. The method may further include an operation of storing information associated with the second image in a memory.

The method may further include an operation of generating a third image by synthesizing the first image and the second image and displaying the third image on the display.

A non-transitory computer-readable recording medium having recorded thereon a program according to one embodiment of the present disclosure is provided. The computer program may execute operations of an electronic device. The operations may include: an operation of selecting a first area where text is to be written on a first image displayed on a display; an operation of determining a representative color of the first area; an operation of determining a color of the text to contrast with the representative color; an operation of generating a second image for the first area including the text in the determined color; and an operation of displaying the second image in the first area of the first image.

Each of the components of the electronic device according to the present disclosure may be implemented by one or more components and the name of the corresponding component may vary depending on a type of the electronic device. Some of the above-described elements may be omitted from the electronic device. Further, some of the components of the electronic device according to the various embodiments of the present disclosure may be combined to form a single entity, and thus, may equivalently execute functions of the corresponding elements prior to the combination.

The embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

What is claimed is:

1. A electronic device comprising:
a display; and
a processor configured to:
select a first area where text is to be written on a first image displayed on the display,
determine a representative color of the first area;
determine a color of the text to contrast with the representative color,
generate a second image for the first area including the text in the determined color, and
display the second image in the first area of the first image.

2. The electronic device of claim 1, wherein the processor is further configured to compare the representative color and a reference color to determine the color of the text based on the comparison.

3. The electronic device of claim 2, wherein the color of the text is determined to be dark when the representative color is brighter than the reference color, and the color of the text is determined to be bright when the representative color is darker than the reference color.

4. The electronic device of claim 2, wherein the processor is further configured to adjust a brightness and a saturation of the second image based on the color of the text and/or the representative color.

5. The electronic device of claim 4, wherein the processor is further configured to:
decrease the brightness and increase the saturation of the second image when the color of the text is bright, and
increase the brightness and decrease the saturation of the second image when the color of the text is dark.

6. The electronic device of claim 4, wherein the processor is further configured to provide a gradation effect by adjusting at least one of the brightness, the saturation, and a transparency of the second image.

7. The electronic device of claim 1, wherein to determine the representative color, the processor is further configured to:
select sampling pixels included in the first area based on a size of the first area, and
determine the representative color based on an average color value of the sampling pixels.

8. The electronic device of claim 7, wherein to determine the representative color, the processor is further configured to:
exclude a pixel from the sampling pixels when a difference between a color value of the pixel and the average color value is larger than or equal to a preset value.

9. The electronic device of claim 1, further comprising a memory, wherein the processor stores information associated with the second image in the memory.

10. A method of operating an electronic device, the method comprising:
selecting a first area where text is to be written on a first image displayed on a display;
determining a representative color of the first area;
determining a color of the text to contrast with the representative color;
generating a second image for the first area including the text in the determined color; and
displaying the second image in the first area of the first image.

11. The method of claim 10, wherein the determining of the color of the text further comprises:
comparing the representative color and a reference color; and
determining the color of the text based on the comparison.

12. The method of claim 11, wherein the determining of the color of the text further comprises:
determining that the color of the text is dark when the representative color is brighter than the reference color; and
determining that the color of the text is bright when the representative color is darker than the reference color.

13. The method of claim 10, wherein the generating of the second image further comprises adjusting a brightness and a saturation of the second image based on the color of the text and/or the representative color.

14. The method of claim 13, wherein the generating of the second image further comprises:
decreasing the brightness and increasing the saturation of the second image when the color of the text is bright; and
increasing the brightness and decreasing the saturation of the second image when the color of the text is dark.

15. The method of claim 13, wherein the generating of the second image further comprises providing a gradation effect by adjusting at least one of the brightness, the saturation, and a transparency of the second image.

16. The method of claim 10, wherein the determination of the representative color further comprises:
selecting sampling pixels included in the first area based on a size of the first area; and
determining the representative color based on an average color value of the sampling pixels.

17. The method of claim 16, wherein the determination of the representative color further comprises excluding a pixel from the sampling pixels when a difference between a color value of the pixel and the average color value is larger than or equal to a preset value.

18. The method of claim 10, further comprising storing information associated with the second image in a memory.

19. The method of claim 10, further comprising generating a third image by synthesizing the first image and the second image and displaying the third image on the display.

20. A non-transitory computer-readable recording medium having recorded thereon a program for executing the method of claim 10.
